(19) United States
(12) Patent Application Publication
(10) Pub. No.: US 2017/0133688 A1
(43) Pub. Date: May 11, 2017

(54) NANOPARTICLES BASED ON PLATINUM AND A RARE EARTH OXIDE, AND THE METHODS FOR THE PRODUCTION THEREOF

(71) Applicants: Centre national de la recherche scientifique (C.N.R.S), PARIS (FR); UNIVERSITE DE POITIERS, POITIERS (FR)

(72) Inventors: Yun LUO, POITIERS (FR); Aurélien HARIBOUX, NOUAILLE-MAUPERTIUS (FR); Nicolas ALONSO-VANTE, BUXEROLLES (FR)

(21) Appl. No.: 15/127,699

(22) PCT Filed: Mar. 27, 2015
(86) PCT No.: PCT/EP2015/056746

§ 371 Date: Sep. 20, 2016

(30) Foreign Application Priority Data
Mar. 27, 2014 (FR) 1452679

(51) Int. Cl. H01M 4/86; H01M 4/88; H01M 4/92; C09D 11/00

(52) U.S. Cl. CPC H01M 4/8657; C09D 11/00; H01M 4/8828; H01M 4/926; H01M 2004/8689

(57) ABSTRACT

The present invention relates to nanoparticles comprising at least one platinum compound comprising at least platinum and at least one rare earth, said rare earth being present in an oxidized form, notably useful for the catalysis of the reduction reaction of dioxygen (RRO) in an acid medium, and methods for the preparation thereof.

The invention also relates to a cathode comprising said nanoparticles and its use notably in a hydrogen fuel cell, also called PEMFC.

The present invention relates to the synthesis of nanoparticles consisting of platinum and of a rare earth oxide, notably useful for catalysis of the reduction reaction of dioxygen (RRO) in an acid medium.

The invention also relates to the elaboration of a cathode comprising said nanoparticles and its use notably in a hydrogen fuel cell, notably called PEMFC (<<proton exchange membrane fuel cell>>).

Nishanth et al. (Electrochem. Comm., 2011, 13, 1465-1468), have demonstrated that the synthesis of catalytic nanoparticles supported on carbon of formula Pt—Y(OH)₃/C give the possibility of improving the kinetics of the RRO in direct methanol fuel cells. Jeon et al. (J. Power Sources, 2011, 196, 1127-1131), have synthesized catalytic nanoparticles supported on carbon of formula Pt₃—Y/C and Pt—Y/C which were applied in the RRO in hydrogen fuel cells in the presence of an acid solution.

The nanoparticles obtained according to the reduction method with sodium borohydride have not been measured.

The object of the invention is to improve the activity of platinum towards the RRO, notably in an acid medium.

The object of the invention is notably to provide nanoparticles which may have satisfactory catalytic properties but which may be prepared according to an industrializable synthesis route.

The object of the invention is further to provide relatively stable catalyst nanoparticles having good catalytic properties in a hydrogen fuel cell.

The object of the invention is also to provide economically cost-effective methods allowing the synthesis on an industrial scale of such nanoparticles.

The object of the invention is further to provide catalytic materials which are less expensive than those presently marketed based on platinum.

In order to attempt to solve these technical problems, the applicant proceeded with tests for synthesizing nanoparticles supported on carbon, said nanoparticles being prepared on the basis of platinum and of a rare earth, such as yttrium or gadolinium, according to the preparation method with a microemulsion called <<water in oil>>.

The applicant surprisingly discovered novel nanoparticles improving the activity of platinum towards the RRO, notably in an acid medium.

The nanoparticles of the invention have satisfactory catalytic properties and may be prepared according to industrializable synthesis routes.

The nanoparticles of the invention are relatively stable with good catalytic properties for their use satisfactorily for example in a hydrogen fuel cell and in particular in a PEMFC.

The present invention also relates to the economically cost-effective methods giving the possibility of contemplating synthesis on an industrial scale of the nanoparticles of the invention.

The applicant also showed that the nanoparticles according to the invention have stable catalytic activity in a PEMFC cell even after a large amount of electrochemical oxidation/reduction cycles.

A first object of the invention relates to nanoparticles based on, comprising at least platinum and at least one rare earth, said rare earth being present in an oxidized form.

Preferably, the platinum component has the following formula (I):

Pt-M_{X}O_{y}

wherein x is the number of rare earth atoms M present and y is the number of oxygen atoms present.

According to an embodiment, x is equal to 1 or 2 and y is equal to 2 or 3 (MₓO_{y}).

Preferably, the rare earth is selected from yttrium, gadolinium, samarium, cerium, europium, praseodymium, scandium, terbium, ytterbium, thulium or any of their mixtures. A <<rare earth>> is also called in the art <<element of a rare earth>> or <<rare earth element>>. These names are equivalent.

In a particular embodiment, the rare earth is yttrium or gadolinium.

According to a specific alternative, MₓO_{y} is Y₂O₃.

According to a specific alternative, MₓO_{y} is Gd₂O₃.

Preferably, the compound based on platinum has a crystalline structure, of the face-centered cubic type.

According to an embodiment, the compound does not comprise any platinum alloy with the rare earth. In particular, according to an embodiment, the compound does not comprise any alloy between platinum and yttrium. According to an embodiment, the compound does not comprise any alloy between platinum and gadolinium.

According to an alternative, the rare earth oxide is present at the surface of the platinum. More particularly, according to an alternative, Y₂O₃ is present at the surface of the platinum. According to another alternative, Gd₂O₃ is present at the surface of the platinum.

According to an alternative, by x-ray photoelectron spectroscopy (XPS) analysis, the surfaces of the nanoparticles have a molar ratio between Pt and Y of between 1 and 5. According to an alternative, the molar ratio between Pt and Y is greater than 2, and preferably greater than 3.

According to an alternative, by XPS analysis, the surface area of the nanoparticles have a molar ratio between Pt and Gd of between 0.5 and 2. According to an alternative, the molar ratio between Pt and Gd is less than 1.

XPS analysis gives the possibility of determining the environment of the platinum in the nanoparticles according to the invention but also the environment of the rare earth. According to these XPS analyses, the structure of the platinum in the nanoparticles according to the invention was not modified since there is no displacement of the peaks of the binding energies corresponding to the lines 4f_{7/2} and 4f_{5/2} of platinum. According to these XPS analyses (for example FIG. 6), there is no presence of the peaks corresponding to the metal core of yttrium and of gadolinium and the peaks corresponding to the atomic layer 3d_{5/2} are strongly shifted relatively to the expected peaks for yttrium and gadolinium metal and are respectively positioned at 158.4 eV and 143.7 eV. The absence of the peaks corresponding to the yttrium and gadolinium metal atoms indicates that these atoms are oxidized.

Preferably, the nanoparticles are supported.

In a particular embodiment, the support may comprise carbon, notably activated carbon. For example, the carbon may be in the form of amorphous carbon, carbon nanotubes, carbon black or graphene.

An example of a support based on carbon black is Vulcan®XC-72 marketed by Cabot.

In another particular embodiment, the support may comprise an oxide-carbon composite. Preferably, the oxide-carbon composite is selected from TiO₂-carbon, WO₃-carbon or SnO₂-carbon or Ti₁₋ₓMₓO₂. (M=Ru, Nb, Sn, and x is from 0 to 1).

Preferably, the mass of the support represents between 5 and 60%, of the total mass of the catalyst. According to an alternative, the mass of the support represents 15 to 25%, for example 20%, of the total mass of the nanoparticles.

According to an alternative, the specific activity of the nanoparticles is greater than or equal to 120, and for example greater than or equal to 130 μA·cm⁻²_{Pt}. In a particular embodiment, the specific activity of the nanoparticles is greater than or equal to 140 μA·cm⁻²_{Pt}, for example greater than or equal to 200 μA·cm⁻²_{Pt}.

According to a particular embodiment, the specific activity of the nanoparticles is comprised between 130 and 300 μA·cm⁻²_{Pt}.

In this particular embodiment, the specific activity of the nanoparticles is comprised between 140 and 280 μA·cm⁻²_{Pt}.

In the sense of the invention, by specific activity is meant the ratio between the current intensity at a potential value of 0.9 V vs. HRE (Hyrdogen Reference Electrode) and the active surface area of the catalyst of the invention, measured after 20 electrochemical cycles (see Example 5).

In an embodiment, the mass activity of the nanoparticles is greater than or equal to 80, for example greater than or equal to 100 mA·mg⁻¹_{Pt}.

In a particular embodiment, the mass activity of the nanoparticles is greater than or equal to 110, for example greater than or equal to 100 mA·mg⁻¹_{Pt}.

In another particular embodiment, the mass activity of the nanoparticles is greater than or equal to 110, and for example greater than or equal to 120 mA·mg⁻¹_{Pt}.

In this particular embodiment, the mass activity of the nanoparticles is comprised between 100 and 200 mA·mg⁻¹_{Pt}.

In a particular embodiment, the mass activity of the nanoparticles is preferably comprised between 120 and 200 mA·mg⁻¹_{Pt}.

In the sense of the invention, by mass activity is meant the ratio between the kinetic current intensity at 0.9 V vs. HRE and the platinum mass used in the catalyst.

The specific activity, and the mass activity were inferred at a potential of 0.9 V vs. HRE. The measurements were carried out by means of the rotating disk electrode technique (Rotating Disk Electrode or RDE) as described in Bard et al, Electrochemical Methods: Fundamentals and Applications, John Wiley & Sons, NY, 2^{nd} Ed., 2002).

In the sense of the invention, the specific activity and the mass activity are measured at a potential of 0.9V vs. HRE on an RDE having a rotation speed of 900 revolutions per minute (rpm).

Preferably, the average size of the nanoparticles is comprised between 0.1 and 10 nm, for example between 0.5 and 5 nm, more specifically between 2 and 3 nm.

In a particular embodiment, at least 90% by number of the nanoparticles have a size comprised between 1 and 4 nm.

In the sense of the invention, the size of the nanoparticles is measured by transmission electron microscopy (TEM) by means of a JEOL® (JEM-2001) microscope equipped with an energy dispersion x-ray spectroscopy device. The sample of nanoparticles is dispersed in the ethanol and then a drop of this dispersion is applied on a copper grid covered with a carbon film. The ethanol is then evaporated. This handling operation was carried out several times in order to obtain several images of these nanoparticles. The Féret diameter of the nanoparticles according to the images obtained by TEM is measured by means of the software package Image J. The size distribution of the nanoparticles was obtained by evaluating the size of 300 nanoparticles on various images obtained by TEM.

Preferably, the compound of formula Pt-MₓO_{y} has a stoichiometric ratio between Pt and M (Pt/M) comprised between 1:2 and 10:1. In the sense of the invention, stoichiometry is measured by ICP-OES (inductively coupled plasma-optical emission spectrometry or plasma torch spectrometry induced by optical emission) (Optima 2000 DV, Perkin-Elmer).

Another object of the invention relates to a method for preparing nanoparticles, notably as defined according to the invention.

In a first alternative, the method for preparing nanoparticles according to the invention comprises a heat treatment step comprising (i) a step for putting into contact precursors of nanoparticles of the invention, comprising platinum and at least one rare earth, with carbon monoxide (CO), (ii) carbonylation of the product obtained by heat treatment, (iii) preferably adding a support, and (iv) a heat treatment at a sufficient temperature in order to form rare earth oxides at least at the surface of the formed nanoparticles.

In particular, said method may comprise:
a. mixing with stirring and under an inert atmosphere a Pt salt, a rare earth salt, an acetate salt and a solvent, for example methanol,
b. heating the mixture obtained previously under an atmosphere containing carbon monoxide.
c. replacing the atmosphere containing carbon monoxide with an inert atmosphere, for example of nitrogen, and preferably adding a support of nanoparticles,
d. evaporating the solvent in order to obtain a powder of nanoparticles,
e. heat treatment of the powder of nanoparticles at a temperature comprised between 80 and 600° C. under an atmosphere of an inert gas, such as for example nitrogen, in the presence of dihydrogen,
f. washing the treated catalytic powder in order to obtain nanoparticles.

Preferably, the preparation according to step a. is carried out for a period ranging from 10 to 30 minutes, preferably of about 15 minutes.

Preferably, the heating according to step b. is carried out for a period ranging from 12 to 36 hours, preferably of about 24 hours.

Also preferably, the heating according to step b. is carried out at a temperature comprised between 55 and 60° C., preferably of about 55° C.,

Preferably, the mixture in step b. is heated under an atmosphere consisting of carbon monoxide.

Preferably, the evaporation of the solvent according to step c. is carried out at a sufficient temperature for substantially removing the solvent, and for example comprised between 60 and 80° C., preferably of about 85° C. in order to obtain the powder of nanoparticles. According to an alternative, the solvent is an organic molecule, for example selected from among dimethyl formamide, ethanol, acetone, methanol, and preferably is methanol.

Preferably, the heat treatment according to step d. is carried out for a period ranging from 30 minutes to 2 hours, preferably 2 hours.

Preferably, the method may further comprise before step d, the introduction under an inert atmosphere and at room temperature of a support into the mixture obtained in step c.

In a particular embodiment, the introduction of a support into the mixture obtained in step b. is carried out with mechanical stirring.

In another particular embodiment, the mixture obtained in step b. is put in the presence of a support for a period ranging from 2 to 24 hours, preferably about 12 hours.

Preferably, the support may be a carbon support, preferably an activated carbon support. For example, activation of the carbon support is carried out at 400° C. under an inert atmosphere for 4 hours.

Preferably, the stoichiometric ratio before reaction between the platinum and the rare earth (Pt/M) in step a. is comprised between 1:1 and 5:1, and for example is 3:1.

According to an alternative, the precursors of nanoparticles comprise at least one platinum salt and at least one rare earth salt. According to an alternative, the precursors of nanoparticles also comprise at least one acetate salt, for example sodium acetate.

Preferably, the platinum salt is Na₂PtCl₆ (for example Na₂PtCl₆.6H₂O).

Preferably, the selected rare earth salts are YCl₃, GdCl₃.

Preferably, the stoichiometric ratio before reaction between Na₂PtCl₆, (1 mole) and sodium acetate (6 moles) is 1/6.

Preferably, the percentage of dihydrogen in the atmosphere of step e. is greater than 1%, and preferably comprised between 1 and 20%, for example comprised between 2 and 10% expressed as a molar fraction of the present gas elements. In a particular embodiment, the percentage of dihydrogen (H₂) in the atmosphere is of about 5%. According to an alternative, the atmosphere comprises an inert gas, such as for example nitrogen (N₂). According to an embodiment, the atmosphere of step e. is a mixed gas H₂/N₂, for example in a proportion of 5/95 expressed as a molar percentage.

Preferably, the method comprises in the step heating to a temperature comprised between about 100 and 600° C., preferably comprised between 300° C. and 500° C.

Preferably, the method may further comprise after step e., drying of the nanoparticles for example at a temperature comprised between 50 and 70° C., preferably of about 60° C.

In a particular embodiment, the drying of the nanoparticles is carried out for a period ranging from 2 to 24 h, preferably of about 12 hours.

Preferably, the washed nanoparticles are filtered in step f.

In a second alternative, the method for preparing nanoparticles according to the invention comprises (v) a step for putting into contact at least one precursor of nanoparticles of the invention, comprising platinum, with an acetate salt and carbon monoxide (CO), (vi) carbonylation of the product obtained by heat treatment, (vii) addition of a precursor of nanoparticles according to the invention comprising at least one coordination polymer (MOF) and at least one rare earth and optionally a support, and (viii) heat treatment at a sufficient temperature in order to form rare earth oxides at least at the surface of the nanoparticles formed. A <<coordination polymer>> is also called in the art a <<metal-organic framework>> or <<MOF>>. These names are equivalent.

The nanoparticles according to the invention obtained according to this alternative of the method may also be designated as NAVLY (HT-900).

In particular, said method may comprise:
a. mixing with stirring and under an inert atmosphere of a Pt salt, of sodium acetate and of a solvent, for example methanol,
b. heating the mixture obtained beforehand under an atmosphere containing carbon monoxide,
c. replacing the atmosphere containing carbon monoxide with an inert atmosphere, for example of nitrogen,
d. adding an MOF compound comprising at least one rare earth and at least one ligand selected from 2-aminoterephthalate, 1,3,5-benzenetricarboxylate, 5-aminoisophtalate, 4,4′-oxybis(benzoate), 1,2,4,5-benzenetetracarboxylate, or 4,4′-biphenyldicarboxylate, and preferably addition of a carbon support, notably carbon nanotubes,
e. evaporating the solvent in order to obtain a powder of nanoparticles,
f. heat treatment of the powder of nanoparticles at a temperature comprised between 100 and 1,000° C. under an atmosphere of an inert gas, such as for example nitrogen,
g. washing the treated catalytic powder in order to obtain nanoparticles,

Preferably, the acetate salt is sodium acetate.

Preferably, the preparation according to step g. is carried out for a period ranging from 10 to 30 minutes, preferably about 15 minutes.

Preferably, the heating according to step h. is carried out for a period ranging from 12 to 36 hours, preferably about 24 hours.

Also preferably, the heating according to step h. is carried out at a temperature from 50 to 60° C., preferably about 55° C.

Preferably, the mixture in step h. is heated under an atmosphere consisting of carbon monoxide.

Preferably, the stoichiometric ratio before reaction between the platinum and the rare earth (Pt/M) in step j. is comprised between 3 and 6, is preferably 3.

Preferably, the amount of MOF compound introduced in step j. is comprised between 10 and 20% by mass, preferably 10% by mass based on the mass of carbon introduced in step j. with the MOF compound.

Preferably, the mixture obtained in step j. is homogenized for a period ranging from 2 to 24 h, preferably for about 12 h.

Preferably, the introduction of the MOF compound in step j. is carried out in an inert atmosphere and at room temperature in the mixture obtained in step i.

Preferably, the introduction of the MOF compound into the mixture obtained in step i. is carried out with mechanical stirring.

Also preferably, the mixture obtained in step i. is put into the presence of the MOF compound for a period ranging from 2 to 24 hours, preferably of about 12 hours.

In a particular embodiment, the method may further comprise in step j., the introduction under an inert atmosphere and at room temperature of a support into the mixture obtained in step i.

Preferably, the MOF compound and the support are mixed together beforehand before their introductions in step j.

Preferably, the introduction of the mixture comprising the MOF compound and the support in step j. is carried out under an inert atmosphere and at room temperature into the mixture obtained in step i.

Preferably, the introduction of the mixture comprising the MOF compound and the support in the mixture obtained in step i. is carried out with mechanical stirring.

Also preferably, the mixture obtained in step j. is put into the presence of the mixture comprising the MOF compound and the support for a period ranging from 2 to 24 hours, preferably of about 12 hours.

Preferably, the support may be carbon nanotubes, preferably multilayer carbon nanotubes which may notably be oxidized.

Advantageously, the carbon nanotubes are activated. For example, the activation of the carbon nanotubes is carried out at 100° C. under an inert atmosphere for 12 hours.

Preferably, the evaporation of the solvent according to step k. is carried out at a sufficient temperature for substantially removing the solvent, and for example comprised between 60 and 90° C., preferably of about 85° C. in order to obtain the powder of nanoparticles. According to an alternative, the solvent is an organic molecule, for example selected from among dimethyl formamide, ethanol, acetone, methanol, and is preferably methanol.

Preferably, the heat treatment according to step k. is carried out for a period ranging from 30 minutes to 2 hours, preferably 2 hours.

Preferably, the stoichiometric ratio before reaction between the platinum and the sodium (Pt/Na) in step g. is 1/6.

Preferably, the precursors of nanoparticles in step g. comprise at least one platinum salt and at least one acetate salt, for example sodium acetate.

Preferably, the platinum salt is Na₂PtCl₆ (for example Na₂PtCl₆.6H₂O).

Preferably, the stoichiometric ratio before reaction between Na₂PtCl₆, (1 mole) and sodium acetate (6 moles) is 1/6.

Preferably, the heat treatment in step l. is carried out at a temperature comprised between about 400 and 1,000° C., preferably comprised between 600° C. and 1,000° C., more preferentially is 900° C.

Preferably, the washing in step m. is carried out with ultra-pure water (MILLI-Q), for example water of resistivity 18 MΩ·cm.

Preferably, the washed nanoparticles are filtered in step m.

In a particular embodiment, the filtration of the nanoparticles is carried out by means of a microporous filter, preferably a microporous filter having porosities with a size of 0.22 μm.

Preferably, the method may further comprise after step m., the drying of the nanoparticles for example at a temperature from 50 to 70° C., preferably of about 60° C.

In a particular embodiment, the drying of the nanoparticles is carried out for a period ranging from 2 to 24 h, preferably of about 12 hours.

Preferably, the nanoparticles have a rare earth loading level from 1 to 4, and for example 2% by mass based on the mass of the nanoparticles.

Another object of the invention relates to the nanoparticles which may be obtained by at least one of the alternatives of the method according to the invention.

The whole of the characteristics, embodiments, alternatives and specific and preferred features described for the nanoparticles of the invention may be combined with the method of the invention, including in its different characteristics, embodiments, alternatives and specific and preferred features, except when this combination is technically impossible.

Another object of the invention relates to an ink comprising nanoparticles according to the invention.

Preferably, the ink may be in the form of an aqueous suspension of nanoparticles according to the invention. According to an alternative, the ink comprises more than 2%, for example more than 5%, by mass of nanoparticles based on the total mass of the solution. Generally, the solution is a mixture of water with one or several additives.

Also preferably, the ink may further comprise a binder giving the possibility of improving the ion conductivity, preferably Nafion®.

In a particular embodiment, the binder may be in liquid form.

An example of a binder is a sulfonated tetrafluoroethylene copolymer for example based on Nafion® marketed by Du Pont de Nemours.

Another object of the invention relates to a cathode for/of a hydrogen fuel cell comprising nanoparticles according to the invention.

In a particular embodiment, the nanoparticles are deposited on the surface of the cathode by means of an ink according to the invention.

Another object of the invention relates to the use of nanoparticles according to the invention as a catalyst for/of RRO in an acid medium.

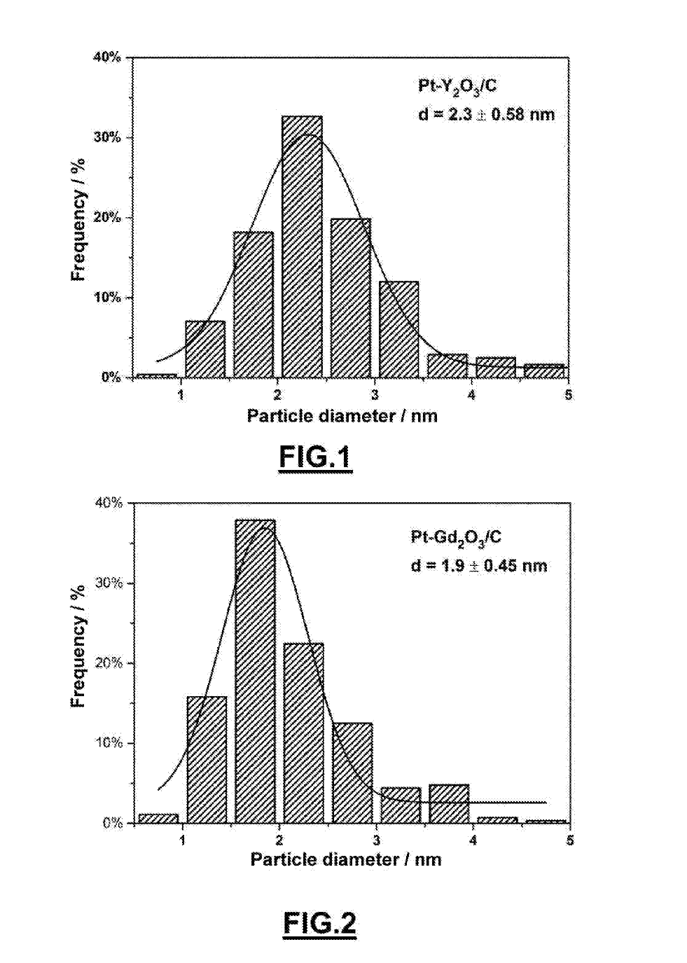

FIG. 1 illustrates the histogram of the distribution of the size of the nanoparticles of the catalyst (Pt—Y₂O₃/C), from images obtained by TEM.

FIG. 2 illustrates the histogram of the distribution of the size of the nanoparticles of a catalyst (Pt—Gd₂O₃/C), from images obtained by TEM.

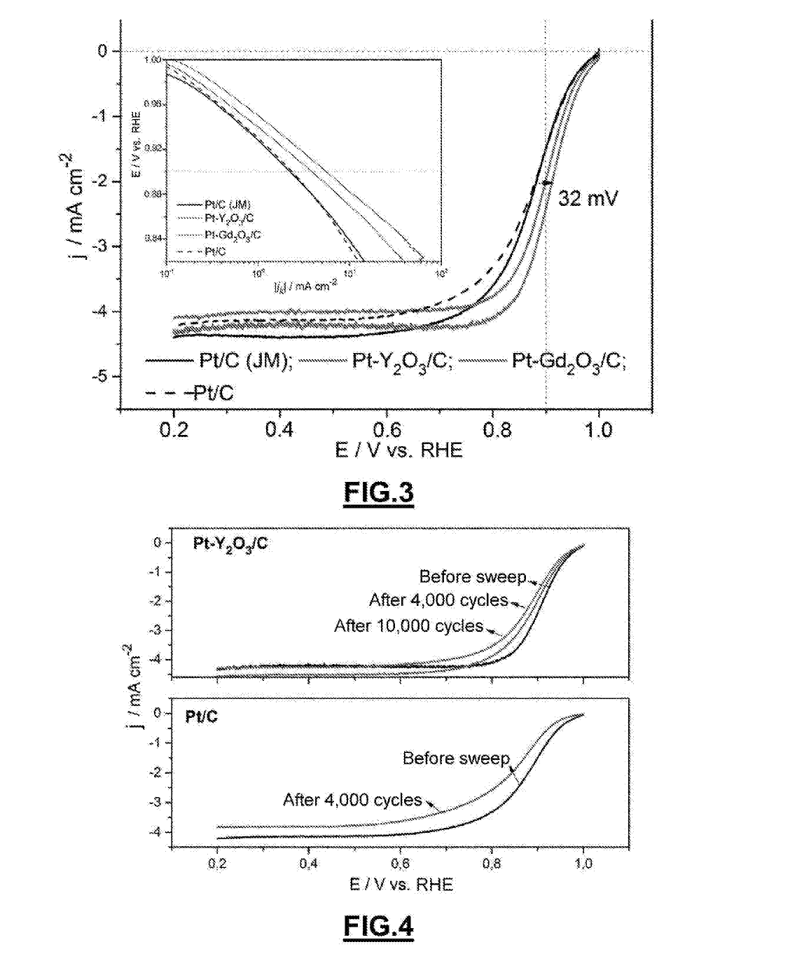

FIG. 3 illustrates voltammograms obtained at a speed of rotation of 900 rpm at 25° C. with nanoparticles of the Pt—Y₂O₃/C, Pt—Gd₂O₃/C, Pt/C, and Pt/C (JM) type, in an electrolyte HClO₄ (0.1M) saturated with oxygen, the potential variation rate being 5 mV/s. The current density is normalized by the geometrical surface area of the electrode. The inserted graph illustrates a plot of Tafel extracted from data stemming from voltammetry experiments with a linear potential variation showing the activity of the nanoparticles towards the RRO.

FIG. 4 illustrates voltammograms with a linear and cyclic sweep (<<Linear sweep voltammograms>>) having the stability of the catalytic activity of the Pt—Y₂O₃/C and Pt/C nanoparticles, before cycling, after 4,000 cycles and after 10,000 cycles, recorded in an HClO₄ electrolyte (0.1 M) saturated with oxygen at a speed of rotation of 900 rpm and at 25° C. The potential variation rate was 5 mV/s. The current density is normalized by the geometrical surface area of the electrode.

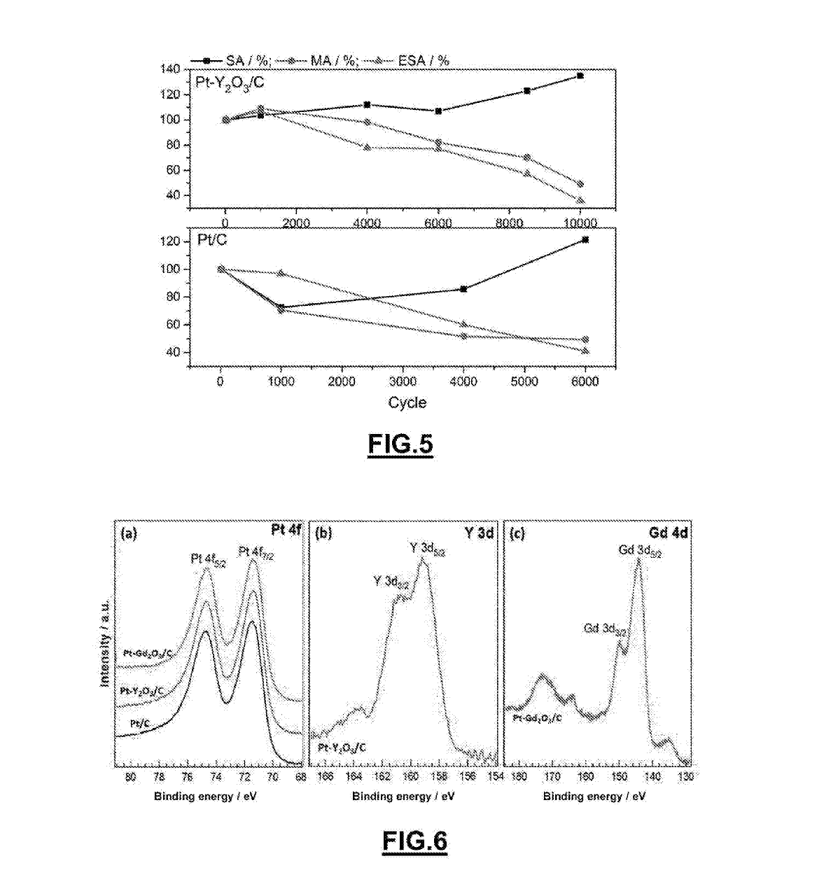

FIG. 5 illustrates the time-dependent change in the specific activity (SA) and of the mass activity (MA) of the Pt—Y₂O₃/C and Pt/C nanoparticles versus the number of cycles.

FIG. 6 illustrates the XPS spectra of the atomic layer Pt 4f in the Pt—Y₂O₃/C, Pt—Gd₂O₃/C and Pt/C nanoparticles, of the atomic layer Y 3d_{5/2} in the Pt—Y₂O₃/C nanoparticles and of the atomic layer Gd 3d_{5/2} in the Pt—Gd₂O₃/C nanoparticles. These spectra were acquired by using a Kα x-ray Mg source,

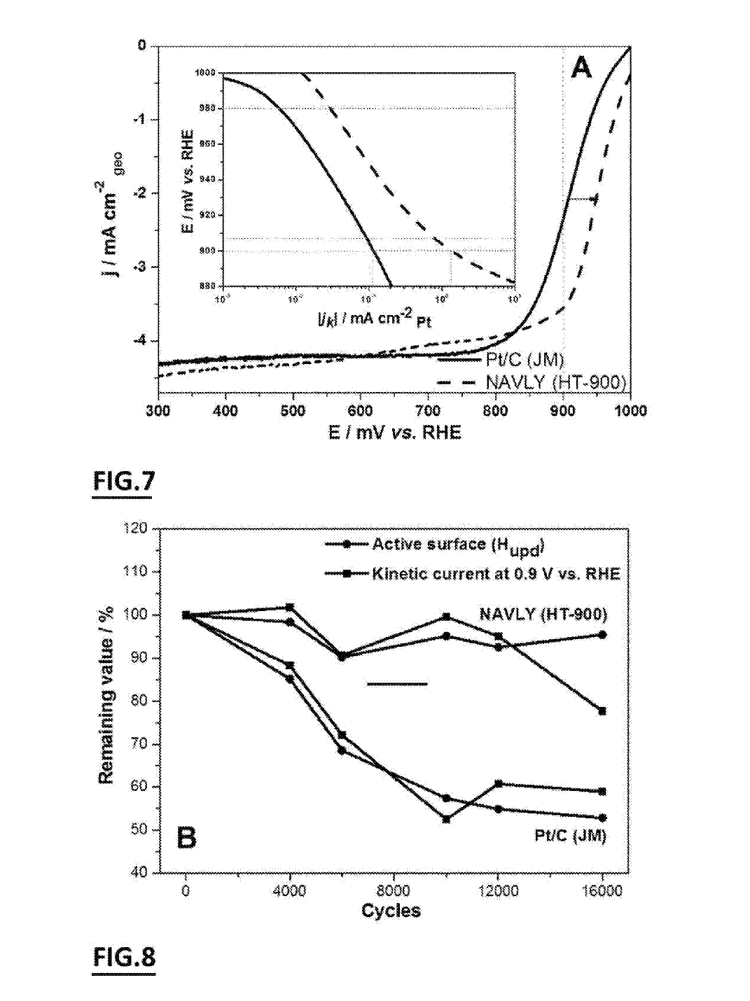

FIG. 7 illustrates the voltamogramms obtained at a speed of rotation of 900 rpm at 25° C. with nanoparticles of the NAVLY (HT-900) and Pt/C (JM) type, in an HClO₄ electrolyte (0.1M) saturated with oxygen, the potential variation rate was 5 mV/s. The current density is normalized by the geometrical surface area of the electrode. The inserted graph illustrates a Tafel plot extracted from data stemming from voltammetry experiments with a linear potential variation showing the activity of the nanoparticles towards RRO.

FIG. 8 illustrates the time-dependent change in the determined surface area of the deposition area with a hydrogen sub-potential (H_{upd}) and of the kinetic current (J_{K}) of the nanoparticles of the NAVLY (HT-900) and Pt/C (JM) type versus the number of cycles.

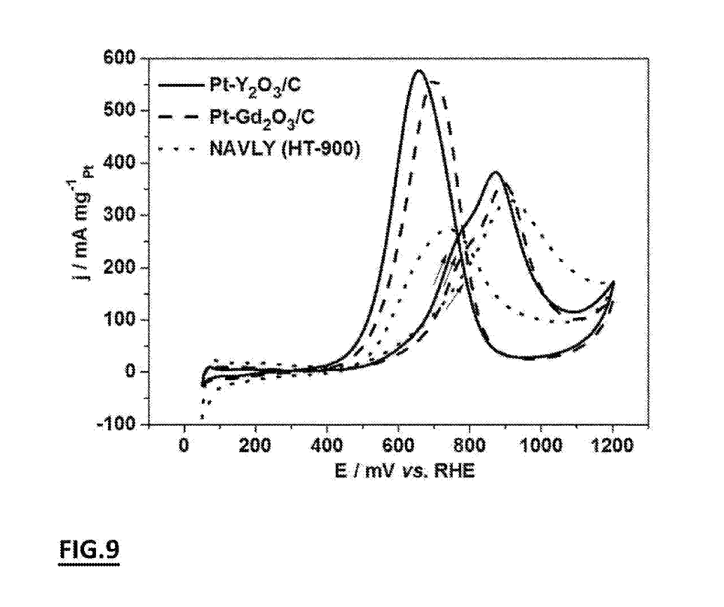

FIG. 9 illustrates the voltammograms obtained at 25° C. with nanoparticles of the Pt—Y₂O₃/C, Pt—Gd₂O₃/C and NAVLY (HT-900) type in an electrolyte comprising water, sulfuric acid in a molar concentration equal to 0.5M and methanol (99.9%, in a molar concentration equal to 0.5M), the potential variation rate being 50 mV/s.

According to the invention, the expression <<comprised between X and Y>> includes the limits X and Y in the range of values.

The different aspects of the invention are illustrated by the following examples. These examples are not a limitation of the scope of the invention.

Unless indicated otherwise, the reagents and the solvents used in the following examples are marketed by Alfa Aesar and are of ACS Reagent quality. The nitrogen, the dioxygen, the argon and the carbon monoxide of purity 99.995 vol. % are marketed by Air Liquide.

In the examples, the pressure is the atmospheric one (101,325 Pa), the temperature is the room temperature (about 25° C.) and the percentages are by mass, unless indicated otherwise.

The method for measuring the size is based on the use of transmission electron microscopy (TEM) by means of a JEOL® (JEM-2001) microscope equipped with an energy dispersion x-ray spectroscopy device. The sample of nanoparticles is dispersed in the ethanol and then a drop of this dispersion is applied on a copper grid covered with a carbon film. The ethanol is then evaporated. This handling was carried out several times in order to obtain several images of these nanoparticles. The Féret diameter of the nanoparticles according to the obtained images, the size of the nanoparticles according to the images obtained by TEM are measured by means of the software package ImageJ. The size distribution of the nanoparticles was achieved by evaluating the size of 300 nanoparticles on various images obtained by TEM. This method is applied for measuring the size of the nanoparticles in Examples 1, 2 and 7.

The method for determining the stoichiometric ratio between the platinum and the rare earth is based on the use of the ICP-OES (Optima 2000 DV, Perkin-Elmer). This method is applied for determining the stoichiometric ratio between Pt and Y or Pt and Gd of the nanoparticles in Examples 1 and 2.

The method for determining the electronic structure of the elements making up the nanoparticles is based on the use of x-ray photoelectron spectroscopy XPS.

The method for determining the specific surface area of the nanoparticles consists of measuring the current obtained at a potential of 0.9 V vs. HRE by using the rotating disk electrode (RDE) in a standard electrochemical cell with 3 electrodes comprising an HClO₄ electrolyte (0.1M) saturated with oxygen at a temperature of 25° C., the potential variation rate was 5 mV/s. The kinetic current density is normalized by the electrochemically active surface area of platinum. This method is applied for measuring the specific activity of the nanoparticles in Examples 5 and 7.

The method for determining the mass activity of the nanoparticles consist of measuring the current obtained at a potential of 0.9 V vs. HRE by using the rotating disk electrode (RDE) in a standard electrochemical cell with 3 electrodes comprising a HClO₄ electrolyte (0.1M) saturated with oxygen at a temperature of 25° C.), the potential variation rate was 5 mV/s. The kinetic current density is normalized by the mass of platinum. This method is applied for measuring the mass activity of the nanoparticles in Examples 5 and 7.

### Example 1. Synthesis of Pt—Y₂O₃/C Nanoparticles

Sodium-hexachloro-platinate hexahydrate (Na₂PtCl₆6H₂O) (31.3% by mass of Pt, 114.6 mg), anhydrous YCl₃ (99%, 16.7 mg) and anhydrous sodium acetate (99%, 126.1 mg) are added into a glass flask and mixed with 25 mL of methanol with magnetic stirring. The whole of the mixture is placed under a nitrogen atmosphere (99%) for 20 mins at the end of which, the nitrogen atmosphere is replaced with a carbon monoxide atmosphere (CO, 99%) for 10 minutes. The circuit is then sealed and the mixture is maintained for 24 h under a CO atmosphere at a temperature set to between 50 and 55° C. with reflux. The stirring is maintained all along the 24 h. After 24 h, the CO atmosphere is replaced with a nitrogen atmosphere and the temperature of the reaction medium decreases down to room temperature.

The carbon support (Vulcan® XC-72, 230.6 mg), activated beforehand at 400° C. under a nitrogen atmosphere for 4 h, is then introduced into the flask. The mixture is homogenized with magnetic stirring for 12 h under a nitrogen atmosphere. The methanol is subsequently totally evaporated by heating the reaction mixture to a temperature of 80° C. and the obtained Pt—Y₂O₃/C powder is dried at 60° C. in air.

The thereby obtained powder is recovered and heated for 2 h at 300° C. under an atmosphere containing molar percentages of 95% of nitrogen and 5% of dihydrogen.

The obtained powder is then washed with ultra-pure water (18 MΩ cm, Milli-Q, Millipore) and then filtered and then dried at 60° C. under an inert atmosphere for 12 h. Pt—Y₂O₃/C nanoparticles are obtained as a powder (297 mg, metal load level of 14.96%).

The Pt—Y₂O₃/C nanoparticles (FIG. 1) have an average size of 2.3±0.58 nm measured by the TEM method.

The Pt—Y₂O₃ nanoparticles have a stoichiometric ratio between Pt and Y (Pt/Y) of 8.5 measured by ICP.

The Pt—Y₂O₃ nanoparticles have an oxide Y₂O₃ as demonstrated in FIG. 6 by the XPS method.

### Example 2. Synthesis of Pt—Gd₂O₃/C Nanoparticles

The Pt—Gd₂O₃/C nanoparticles are obtained according to the experimental procedure described in Example 1 from sodium-hexahloro-platinate hexahydrate (144.2 mg), from GdCl₃ (22.5 mg) and from sodium acetate (126.1 mg).

Pt—Gd₂O₃/C nanoparticles are obtained as a powder (297 mg, metal load level of 15.41% measured by ICP).

The Pt—Gd₂O₃/C nanoparticles (FIG. 2) have an average size of 1.9±0.45 nm measured by the TEM method.

The Pt—Gd₂O₃ nanoparticles have a stoichiometric ratio between Pt and Gd (Pt/Gd) of 3.5, measured by ICP.

The Pt—Gd₂O₃ nanoparticles have an oxide Gd₂O₃ as demonstrated in FIG. 6 by the XPS method.

### Example 3. Preparation of a Cathode Comprising Pt—Y₂O₃/C Nanoparticles

A catalytic ink is prepared with 10 mg of Pt—Y₂O₃/C nanoparticles, obtained in Example 1 suspended in 1.25 mL of ultra pure water (MILLIQ quality) and 250 μL of a 5% Nafion® (Aldrich) solution. The obtained suspension is homogenized for 2 h.

Next, 3 μL of this ink are deposited on the glassy carbon electrode (GCE) having a diameter of 3 mm and polished beforehand with a mixture of alumina and ultra-pure water (18 MΩ cm, Milli-Q, Millipore). This electrode is then dried under an argon atmosphere and is used as the working electrode (WE).

The surface area of the disk of the end piece is 0.07 cm². The carbon disk with the catalytic layer is used as a working electrode (WE). The metal (Pt+Y) content of the catalytic layer on the WE is 52 μg·cm⁻².

### Example 4. Preparation of a Cathode Comprising Pt—Gd₂O₃/C Nanoparticles

A working electrode is prepared according to the experimental procedure described in Example 3 from a catalytic ink comprising 10 mg of Pt—Gd₂O₃/C nanoparticle powder obtained in Example 2 suspended in 1.25 mL of ultra pure water (MILLIQ quality) and 250 μL of a 5% Nafion® (Aldrich) solution.

The metal (Pt+Gd) content of the catalytic layer on the WE is 52 μg·cm⁻².

### Example 5. Electrochemical Measurements

The tested (working electrode—WE) cathodes are:
a cathode comprising Pt—Y₂O₃/C nanoparticles prepared according to the experimental procedure of Example 3,
a cathode comprising Pt—Gd₂O₃/C nanoparticles prepared according to the experimental procedure of Example 4,
a cathode comprising Pt/C nanoparticles prepared according to the experimental procedure of Example 3, where the Pt/C nanoparticles are prepared according to the experimental procedure of Example 1 from sodium-hexachloro-platinate hexahydrate (144 mg) and sodium acetate (126 mg).

The electrochemical measurements were recorded on a Potentiostat/Galvanostat Autolab and carried out in a standard electrochemical cell with 3 electrodes. The RDE is used for studying the activity of the RRO. The counter electrode (CE) and the reference electrode (RE) are respectively a glassy carbon plate and the hydrogen reversible electrode (HRE). Perchloric acid 0.1 mol/L is used as an electrolyte. The surface area of the WE electrode is first of all electrochemically cleaned by carrying out cycles at 50 mV/s between 0.05 and 1.2 V relatively to the HRE electrode until stable cyclic voltammograms (CVs) are obtained. During the carrying out of the electrochemical measurements, the electrode is first of all cycled 20 times between 0.05 and 1.2 V relatively to HRE in the electrolyte saturated beforehand with nitrogen. Subsequently, the electrolyte is saturated with dioxygen for 10 minutes. The experiments aiming at characterizing the catalytic activity of the catalysts towards RRO are carried out by means of a rotating disk electrode (RDE). Speeds of rotation of 400, 900, 1,600 and 2,500 rpm are used for studying the kinetics of the RRO. In order to carry out these experiments, linear voltammetry is used. The electrode then undergoes a negative potential variation between 1.1 and 0.2 V relatively to HRE. The linear potential variation rate is 5 mV/s.

The voltammograms obtained with the cathodes comprising Pt—Y₂O₃/C, Pt—Gd₂O₃/C and Pt/C nanoparticles respectively are shown in FIG. 3.

At the potential of 0.9 V relatively to HRE and at 900 rpm, it is observed that the specific activity of Pt—Y₂O₃/C and Pt—Gd₂O₃/C nanoparticles is 278 μA·cm⁻²_{Pt} and of 142 μA·cm⁻²_{Pt} respectively unlike the specific activity of Pt/C nanoparticles which is 100 μA·cm⁻²_{Pt}. The specific activity of the catalyst nanoparticles according to the invention is therefore at least 1.4 times greater than that of the nanoparticles based on platinum not comprising any rare earth oxide.

At the potential of 0.9 V relatively to HRE, it is also observed that the mass activity of Pt—Y₂O₃/C and Pt—Gd₂O₃/C nanoparticles is 194 mA·mg⁻¹_{Pt} and of 112 mA·mg⁻¹_{Pt} respectively unlike the mass activity of Pt/C nanoparticles which is 54.9 mA·mg⁻¹_{Pt}.

The mass activity of the catalyst nanoparticles according to the invention is therefore at least twice greater than that of the nanoparticles based on platinum not comprising any rare earth oxide.

The catalytic activity of the Pt—Y₂O₃/C and Pt—Gd₂O₃/C nanoparticles towards the RRO is increased with respect to the catalytic activity of the Pt/C nanoparticles with a positive displacement of the half-wave potential for Pt—Y₂O₃/C and Pt—Gd₂O₃/C respectively of 32 and 25 mV relatively to HRE with respect to the half-wave potential of Pt/C.

The catalytic activity of the nanoparticles according to the invention towards the RRO is therefore 4-5 times greater than the catalytic activity of platinum nanoparticles towards the RRO. The kinetics of the RRO catalyzed by nanoparticles according to the invention is more than twice greater than the kinetics of the RRO catalyzed by platinum nanoparticles.

### Example 6. Stability of the Cathodes Respectively Comprising Pt—Y₂O₃/C Nanoparticles

The tested cathodes are:
a cathode comprising Pt—Y₂O₃/C nanoparticles prepared according to the experimental procedure of Example 3,
a cathode comprising Pt/C nanoparticles prepared according to the experimental procedure of Example 3. The Pt/C nanoparticles are prepared according to the experimental procedure of Example 1 from sodium-hexachloro-platinate hexahydrate (144 mg) and from sodium acetate (126 mg).

The electrochemical measurements were recorded by means of a potentiostat/galvanostat from Autolab and carried out in a standard electrochemical cell with 3 electrodes. The RDE is used for studying the activity of the catalysts towards the RRO. The counter electrode (CE) and the reference electrode (RE) are respectively a glassy carbon plate and the hydrogen reversible electrode (HRE). Perchloric acid at 0.1 mol/L is used as an electrolyte. The surface area of the working electrode WE is first of all cleaned electrochemically by carrying out a cycle at 50 mV/s between 0.05 and 1.2 V relatively to HRE electrode until stable cyclic voltammograms (CVs) are obtained.

The electrochemical measurements were conducted when the electrode is cycled 1,000, 4,000, 6,000, 8,500 and 10,000 times between 0.1 and 1.0V relatively to the HRE with a potential linear variation rate of 50 mV/s in the electrolyte saturated beforehand with nitrogen. Subsequently, the electrolyte is saturated with dioxygen for 10 mins. The RRO experiments are conducted with a rotating disk electrode (RDE). Speeds of rotation of 400, 900, 1,600 and 2,500 rpm are used for studying the kinetics of the RRO. In order to conduct these experiments, linear voltammetry is used.

The voltammograms obtained with the cathodes respectively comprising Pt—Y₂O₃/C and Pt/C nanoparticles are shown in FIG. 4. FIG. 5 illustrates the time-dependent change of the specific activity (SA) and of the mass activity (MA) of the Pt—Y₂O₃/C and Pt/C nanoparticles versus the number of cycles. The active surface area (ESA) is calculated from the coulombmetry of the oxidation peak of CO (CO-stripping) which is divided by a reference coulombmetry of 420 μC·cm⁻². Thus, the electrochemically active surface area of the catalyst (ESA) is obtained. The specific activity (SA) is calculated by dividing the kinetic current at 0.9 V/HRE by the ESA. The mass activity (MA) is calculated by dividing the kinetic current at 0.9 V/HRE by the platinum mass in the catalyst.

After 4,000 voltammetric cycles, the specific surface area (SA) of Pt—Y₂O₃/C is 1.3 times greater than that of Pt/C, and the specific mass is 1.81 times greater than that of Pt/C.

The mass activity of nanoparticles according to the invention towards the RRO is therefore 1.89 times greater than the kinetics of the platinum nanoparticles towards the RRO after 6,000 cycles.

### Example 7. Comparison of the Specific Activity and of the Mass Activity of the Pt—Y₂O₃/C and Pt—Gd₂O₃/C Nanoparticles Respectively Obtained by the Method According to the Invention and by the <<Water in Oil>> Method

Preparation of Pt—Y₂O₃/C Nanoparticles According to the <<Water in Oil>> Method.

Two microemulsions are prepared by mixing 5.60 mL of Brij30 (Sigma-Aldrich), 1 mL of ultra pure water (Milli-Q, Millipore) and 27.35 mL of n-heptane (Sigma-Aldrich). 9.8 mg of YCl₃ and 84.3 mg of sodium-hexachloro-platinate hexahydrate are dissolved in the aqueous phase of the first microemulsion.
114 mg of sodium borohydride are dissolved in the aqueous phase of the second microemulsion.

Both microemulsions obtained are mixed and the carbon support, activated beforehand at 400° C. under a nitrogen atmosphere for 2 h (Vulcan® XC-72, 135 mg), is then introduced. The mixture is then mechanically stirred for 2 h under a nitrogen atmosphere. The obtained supported catalyst nanoparticles are filtered, washed several times with acetone and then with ultra-pure water (18 MΩ·cm), and then dried at 60° C. for 12 h. The thereby obtained powder of nanoparticles is heated for 2 h to 100° C. under an atmosphere containing molar percentages of 95% of nitrogen and 5% of dihydrogen.

Pt—Y₂O₃/C nanoparticles are obtained as a powder (144 mg, metal load level of 17% by ICP).

The Pt—Y₂O₃/C nanoparticles have an average size of 2.3±0.59 nm, measured by the TEM method.

Preparation of Pt—Gd₂O₃/C Nanoparticles According to the <<Water in Oil>> Method.

The Pt—Gd₂O₃/C nanoparticles are prepared according to the <<water in oil>> experimental procedure described above from GdCl₃ (15.8 mg) and from sodium-hexachloro-platinate hexahydrate (78.7 mg).

Both obtained microemulsions are mixed and the carbon support, activated beforehand at 400° C. under a nitrogen atmosphere for 2 h (Vulcan® XC-72, 147 mg), is then introduced. The obtained supported catalyst nanoparticles are filtered, washed several times with acetone and then with ultra-pure water (18 MΩ·cm), and then dried at 60° C. for 12 h. The thereby obtained powder of nanoparticles is heated for 2 h to 100° C. under an atmosphere containing molar percentages of 95% of nitrogen and 5% of dihydrogen.

Pt—Gd₂O₃/C nanoparticles are obtained as a powder (142 mg, metal load level of 15.4% by ICP).

The Pt—Gd₂O₃/C nanoparticles have an average size of 2.25±0.48 nm measured by the TEM method.

Preparation of a Cathode

The cathodes respectively comprising Pt—Y₂O₃/C and Pt—Gd₂O₃/C nanoparticles respectively obtained by the “water in oil” method described above, are prepared according to the experimental procedure described in Example 3.

Electrochemical Measurements

The specific activity and the mass activity of the Pt—Y₂O₃/C and Pt—Gd₂O₃/C nanoparticles obtained by the <<water in oil>> method were measured under the same experimental conditions as those applied in the experimental procedure described in Example 5.

At the potential of 0.9 V vs. HRE, it is observed that the specific activity of the Pt—Y₂O₃/C and Pt—Gd₂O₃/C nanoparticles is 54.3 μA·cm⁻²_{Pt} and of 34.3 μA·cm⁻²_{Pt} unlike the specific activity of the Pt—Y₂O₃/C and Pt—Gd₂O₃/C nanoparticles according to the invention which is 278 μA·cm⁻²_{Pt} and 142 μA·cm⁻²_{Pt}, respectively.

At a potential of 0.9 V relatively to HRE, it is observed that the mass activity of the Pt—Y₂O₃/C and Pt—Gd₂O₃/C nanoparticles is 23.1 mA·mg⁻¹_{Pt} and of 13.4 mA·mg⁻¹_{Pt} respectively unlike the mass activity of the Pt—Y₂O₃/C and Pt—Gd₂O₃/C nanoparticles according to the invention which is 194 mA·mg⁻¹_{Pt} and 112 mA·mg⁻¹_{Pt} respectively.

The catalytic activity of the nanoparticles according to the invention is 8.5 greater than that of the nanoparticles obtained by the <<water in oil>> method.

### Example 8: Synthesis of NAVLY (900-HT) Nanoparticles

Preparation of the Support

The support was prepared according to the experimental procedure described in the publication of Orfanidi et al., Appl. Catal. B, 2011, 106, 379.

20 mL of nitric acid (HNO₃, 65% by weight) were added to 0.2 g of multilayer carbon nanotubes (purity: 97%, size: 10-30 nm, Nanothinx S.A.). The thereby obtained solution was heated with reflux and then mixed at room temperature for 48 h.

The obtained black powder was filtered and washed with ultra pure water (Milli Q, Millipore) until a filtrate was obtained having a pH equivalent to 7, and then dried at 100° C. for 12 h in order to obtain 0.19 g of a support of multilayer carbon nanotubes and of oxides (MWCNT) with a yield of 95%.

Preparation of the Compound MOFCe(HATPT)(ATPT).nH₂O Wherein ATPT Represents the Aminoterephthalate Ligand and n is Comprised Between 8 and 11 (INSAR-1(Ce))

2 moles of sodium hydroxide (NaOH) were added into a suspension comprising 1 mole of 2-aminoterephthalic acid (H₂ATPT, Acros Organics). The thereby obtained solution was dry evaporated. The thereby obtained powder was added into ethanol 99.8%, CHROMASOLV, Sigma-Aldrich) in an amount of 10 mL of ethanol for 10 mg of powder, refluxed with stirring for 1 h, filtered, rinsed with twice distilled water and dried in air at room temperature.

The ligand di-sodium 2-aminoterephthalate (Na₂ATPT) as a yellow powder was obtained with a yield of 90%.

30 to 50 mL of hydrochloric acid (37%, Acros Organics) were added drop wise to a solution comprising 100 mg of cerium oxide (STREM Chemicals) and 20 to 30 mL of distilled water with mechanical stirring until a transparent solution was obtained. The thereby obtained solution was dry evaporated. The obtained residue was dissolved in 80 to 100 mL of ethanol and then of diethyl-ether 99.9%, CHROMASOLV, Sigma-Aldrich) was added drop wise until CeCl₃ was obtained as a precipitate. The thereby obtained solution was filtered and the precipitate was washed with 20 to 30 mL of diethyl-ether, and then dried in a drier at room temperature for a period comprised between 12 and 24 h.

The synthesis of the MOF Ce(HATPT)(ATPT).nH₂O compound was achieved according to the experimental procedure described in the publication of Luo et al., Inorg. Chem. Acta, 2011, 368, 170.

2 moles of CeCl₃ and 3 moles of the ligand Na₂ATPT obtained above were added to 50 mL of distilled water under stoichiometric conditions with mechanical stirring until a precipitate of a pale yellow color was formed. The thereby obtained solution was filtered and the precipitate was washed with distilled water, and then dried in air and at room temperature. The obtained residue is the compound MOF: Ce(HATPT)(ATPT).nH₂O with a yield of 90%.

Preparation of the NAVLY (HT-900) Nanoparticles

The synthesis of the NAVLY (HT-900) nanoparticles was achieved according to the procedure described in the publication of N. Alonso-Vante, Fuel Cell, 2006, 6, 182.

Sodium-hexachloro-platinate hexahydrate (Na₂PtCl₆6H₂O) (31.3% by mass of Pt, 72.1 mg, Alfar Aesar) and anhydrous sodium acetate (99%, 63.1 mg) are added in a glass flask and mixed with 25 mL of methanol 99.9%, CHROMASOLV, Sigma-Aldrich) with magnetic stirring.

The whole of the mixture is placed under a nitrogen atmosphere (99%) for 20 mins at room temperature after which, the nitrogen atmosphere is replaced with a carbon monoxide (CO, 99%) atmosphere for 10 minutes. The set-up is then sealed and the mixture is maintained for 24 h under a CO atmosphere at a temperature of 55° C. with reflux. Stirring is maintained all along the 24 h. After 24 h, the thereby obtained solution is cooled to room temperature and then 115.2 mg of MWCNT obtained above mixed beforehand with 14.2 mg of INSAR-1(Ce) obtained below are added to this solution.

The set-up is again sealed under a nitrogen atmosphere (99%) and the mixture is homogenized with magnetic stirring for 12 h under a nitrogen atmosphere. The methanol is subsequently totally evaporated by heating the reaction mixture to a temperature of 90° C. and the obtained powder is dried at 60° C. in air for 12 h.

The dried powder is recovered and transferred into a ceramic boat subsequently introduced into an oven. In parallel, another ceramic boat filled with an amount of urea comprised between 20 and 50 mg was placed in the oven, beside the ceramic boat filled with the dried powder. The oven was heated to 50° C. under an argon atmosphere 99.99%) for 30 min, and the temperature was then increased at a rate of 10° C./min until a temperature of 900° C. is attained, maintained for 2 h under an argon atmosphere 99.99%), and then the temperature was reduced down to room temperature under an argon atmosphere. The obtained powder is then washed with ultra-pure water (18 MΩ cm, Milli-Q, Millipore) and then filtered and then dried at 60° C. under an inert atmosphere for 12 h. NAVLY (HT-900) nanoparticles are obtained as a powder (160 mg, platinum load level of 18.9% and Cerium load level of 2.2% by mass based on the total mass of nanoparticles).

### Example 9: Preparation of a Cathode Comprising NAVLY (HT-900) Nanoparticles

A catalytic ink is prepared with 5 mg of NAVLY (HT-900) nanoparticle powder obtained in Example 8, suspended in 532.5 mL of ultra pure water (MILLIQ quality), 77.5 mL of 2-propanol and 40 μL of a 5% Nafion®(Aldrich) solution. The obtained suspension is homogenized for 2 h.

Subsequently, 3 μL of this ink are deposited on the glassy carbon electrode (GCE) having a diameter of 3 mm and polished beforehand with alumina powder A5, and then successively cleaned with ultra-pure water (18 MΩ cm, Milli-Q, Millipore), ethanol and then ultra-pure water. This electrode is then dried under an argon atmosphere and is used as a working electrode (WE).

The surface area of the disk of the end-piece is 0.07 cm². The carbon disk with the catalytic layer is used as a working electrode (WE). The (Pt+Y) metal content of the catalytic layer on the WE is 59.4 μg·cm⁻².

### Example 10. Electrochemical Measurements

The tested (working electrode—WE) cathodes are:
a cathode comprising NAVLY (HT-900) nanoparticles prepared according to the experimental procedure of Example 9,
a cathode comprising Pt/C (JM) nanoparticles prepared according to the experimental procedure of Example 3, wherein the Pt/C (JM) nanoparticles are marketed under the brand of Johnson-Matthey® and comprise 20% by mass of platinum supported on carbon black based on the total mass of the nanoparticles.

The electrochemical measurements were recorded under the same experimental conditions as those described in Example 5.

The voltammogram obtained with the cathodes respectively comprising NAVLY (HT-900) and Pt/C (JM) type nanoparticles is shown in FIG. 7.

At the potential of 0.9 V relatively to the HRE and at 900 rpm, it is observed that the specific activity of the NAVLY (HT-900) type nanoparticles is 1,250 μA·cm⁻²_{Pt} unlike the specific activity of Pt/C (JM) nanoparticles which is 117 μA·cm⁻²_{Pt}.

The specific activity of the catalyst nanoparticles of NAVLY (HT-900) type according to the invention is therefore at least 12 times greater than that of the nanoparticles based on platinum not comprising any rare earth oxide.

At the potential of 0.9 V relatively to the HRE, it is also observed that the mass activity of nanoparticles of the NAVLY (HT-900) type is of 830 mA·mg⁻¹_{Pt} unlike the mass activity of the Pt/C (JM) nanoparticles which is 86 mA·mg⁻¹_{Pt}.

The mass activity of the catalyst nanoparticles according to the invention is therefore at least 10 times greater than that of the nanoparticles based on platinum not comprising any rare earth oxide.

The catalytic activity of the nanoparticles of the NAVLY (HT-900) type towards the RRO is greatly increased relatively to the catalytic activity of the Pt/C (JM) nanoparticles with a positive displacement of the half-wave potential for nanoparticles of the NAVLY (HT-900) type of 25 mV relatively to HRE with respect to the Pt/C half-wave potential.

The catalytic activity of the nanoparticles according to the invention towards the RRO is therefore ten times greater than the catalytic activity of platinum nanoparticles towards the RRO. The kinetics of the RRO catalyzed by nanoparticles according to the invention is fifteen times greater than the kinetics of the RRO catalyzed by platinum nanoparticles.

### Example 11. Stability of the Cathodes Respectively Comprising Nanoparticles of the NAVLY (HT-900) Type

The tested cathodes are:
a cathode comprising nanoparticles of the NAVLY (HT-900) type prepared according to the experimental procedure of Example 9,
a cathode comprising Pt/C (JM) nanoparticles prepared according to the experimental procedure of Example 3. The Pt/C nanoparticles are marketed under the brand of Johnson-Matthey®(JM) and comprised 20% by mass of platinum supported on carbon black based on the total mass of the nanoparticles.

The electrochemical measurements were recorded under the same experimental conditions as those described in Example 6.

The voltammogram obtained with the cathodes respectively comprising nanoparticles of the NAVLY (HT-900) and Pt/C (JM) type are shown in FIG. 8.

FIG. 8 illustrates the time-dependent change in the active surface area from H_{upd} and from the kinetic current at 0.9 V vs RHE of the nanoparticles of type NAVLY (HT-900) and Pt/C (JM) versus the number of cycles. The active surface area (ESA) is calculated from coulombmetry in the region H_{upd} which is divided by a reference coulombmetry of 210 μC·cm⁻². The electrochemically active surface area is of the catalyst (ESA) is thereby obtained.

After 16,000 voltammetric cycles, the remaining active surface area of the nanoparticles of the NAVLY (HT-900) type is 95%, and 53% for Pt/C (JM),

The kinetic current remaining at 0.9 V vs HRE of the nanoparticles of the NAVLY (HT-900) type according to the invention towards the RRO is 84%, and 47% for Pt/C (JM).

### Example 12: Measurement of the Mass Activity of the Pt—Y₂O₃/C, Pt—Gd₂O₃/C and NAVLY (HT-900) Type Nanoparticles Obtained by the Methods According to the Invention in the Methanol Oxidation Reaction (MOR)

Preparation of the Working Electrodes Comprising the Pt—Y₂O₃/C, Pt—Gd₂O₃/C and NAVLY (HT-900) Type Nanoparticles Respectively.

A catalytic ink is prepared with 5 mg of a powder of nanoparticles Pt—Y₂O₃/C obtained in Example 1, suspended in 1 mL of ethanol and 20 μL of a 10% Nafion®(Aldrich) solution. The obtained suspension is homogenized for 10 minutes.

Next, 20 μL of this ink are deposited on the glassy carbon electrode (GCE) having a diameter of 3 mm and polished beforehand with a mixture of alumina and ultra-pure water (18 MΩ cm, Milli-Q, Millipore). This electrode was then dried under an argon atmosphere and is used as a working electrode (WE).

The cathodes comprising Pt—Gd₂O₃/C and NAVLY (HT-900) type are prepared according to the experimental procedure described above.

The electrochemical measurements were recorded on a potentiostat/galvanostat from Autolab and conducted in a standard electrochemical cell with 3 electrodes comprising:
an electrode respectively comprising Pt—Y₂O₃/C, Pt—Gd₂O₃/C and NAVLY (HT-900) type nanoparticles as a working electrode (WE),
a glassy carbon plate as a counter-electrode,
a reversible hydrogen electrode (HRE) as a reference electrode, and
an acid electrolytic solution comprising water, sulfuric acid (96%, Merck) in a molar concentration equal to 0.5M and methanol (99.9%, Sigma-Aldrich) in a molar concentration equal to 0.5M.

The working electrode surface WE is first of all electrochemically cleaned by performing cycles at 50 mV/s between 0.05 and 1.2 V relatively to the reference electrode until stable cyclic voltammograms (CVs) are obtained.

The voltammograms obtained with the electrodes respectively comprising Pt—Y₂O₃/C, Pt—Gd₂O₃/C and NAVLY (HT-900) type nanoparticles are shown in FIG. 9.

It is observed that the mass activity at the upward peaks of the Pt—Y₂O₃/C, Pt—Gd₂O₃/C nanoparticles and of the NAVLY (HT-900) type is 382 mA·mg⁻¹_{Pt}, 358 mA·mg⁻¹_{Pt} and 318 mA·mg⁻¹_{Pt} respectively unlike the mass activities of the nanoparticles comprising a rare earth oxide on which is present at the surface platinum, notably such as the nanoparticles described in the documents of Tang et al., J. Power Sources, 2006, 162, 1067-1072 and US 2013/165318 which are less than 93 mA·mg⁻¹_{Pt}.

The mass activity of the catalyst nanoparticles according to the invention is therefore at least 3 times greater than that of the nanoparticles described in the documents of Tang et al., J. Power Sources, 2006, 162, 1067-1072 and US 2013/165318.

It was demonstrated that this large difference in mass activity between the nanoparticles according to the invention and the nanoparticles such as those described in the documents of Tang et al., J. Power Sources, 2006, 162, 1067-1072 and US 2013/165318 is due to a structural difference between both types of nanoparticles based on platinum and on a rare earth oxide, notably the nanoparticles according to the invention have the rare earth in an oxidized form at the surface of the platinum unlike the nanoparticles described in these documents which comprise platinum and oxidized rare earth.

1-22. (canceled)

23. Nanoparticles comprising at least one platinum compound comprising at least platinum and at least one rare earth, said rare earth being present as an oxide at the surface of the platinum.

24. The nanoparticles according to claim 23, wherein the platinum compound has the following formula (I):
Pt-MₓO_{y}
wherein x is the number of the present rare earth atoms M and y is the number of present oxygen atoms.

25. The nanoparticles according to claim 23, wherein the nanoparticles are supported.

26. The nanoparticles according to claim 23, wherein said rare earth element is selected from the group consisting of yttrium, gadolinium, samarium, cerium, europium, praseodymium, scandium, terbium, ytterbium, thulium and any of their mixtures thereof.

27. The nanoparticles according to claim 23, wherein said selected from the group consisting of the rare earth element is yttrium or gadolinium.

28. The nanoparticles according to claim 23, wherein the specific activity of said nanoparticles is greater than or equal to 120 μA·cm⁻²_{Pt}.

29. The nanoparticles according to claim 23, wherein the mass activity of said nanoparticles is greater than or equal to 80 mA·mg⁻¹_{Pt}.

30. The nanoparticles according to claim 23, wherein the average size of the nanoparticles is comprised between 0.1 and 10 nm.

31. A method for preparing nanoparticles comprising a heat treatment step comprising:
(i) putting into contact precursors of nanoparticles, comprising platinum and at least one rare earth, with carbon monoxide (CO),
(ii) performing a heat treatment for the carbonylation of the product obtained and,
(iii) optionally adding a support, and
(iv) at a temperature sufficient for forming rare earth oxides at least at the surface of the nanoparticles formed.

32. The method according to claim 31 comprising:
a. Mixing with stirring and under an inert atmosphere a Pt salt, a rare earth salt, an acetate salt, and a solvent,
b. Heating the mixture obtained beforehand under an atmosphere comprising carbon monoxide,
c. Replacing the atmosphere containing carbon monoxide with an inert atmosphere, for example of nitrogen, and optionally addition of a support of nanoparticles,
d. Evaporating the solvent in order to obtain a powder of nanoparticles,
e. Heat treatment of the powder of nanoparticles at a temperature comprised between 80° C. and 600° C. under an atmosphere comprising an inert gas, in the presence of dihydrogen, and
f. Washing the treated catalytic powder in order to obtain nanoparticles.

33. The method according to claim 31, wherein the method further comprises before step d, the introduction under an inert atmosphere and at room temperature of a support into the mixture obtained in step c.

34. The method according to claim 31, wherein the support is a carbon support.

35. A method for preparing nanoparticles comprising:
(v) putting into contact at least one precursor of nanoparticles comprising platinum with an acetate salt and carbon monoxide (CO),
(vi) performing a heat treatment for the carbonylation of the product obtained,
(vii) adding a precursor of nanoparticles comprising at least one coordination polymer (MOF) and at least one rare earth, and optionally a support, and
(viii) performing a heat treatment at a sufficient temperature in order to form rare earth oxides at least at the surface of the nanoparticles formed.

36. The method according to claim 35 comprising:
g. mixing with stirring and under an inert atmosphere a Pt salt, sodium acetate and a solvent,
h. heating the mixture obtained beforehand under an atmosphere containing carbon monoxide,
i. replacing the atmosphere containing carbon monoxide with an inert atmosphere,
j. adding a MOF compound comprising at least one rare earth and at least one ligand selected from among 2-aminoterephthalate, 1,3,5-benzenetricarboxylate, 5-aminoisophtalate, 4,4′-oxybis(benzoate), 1,2,4,5-benzenetetracarboxylate, or 4,4′-biphenyldicarboxylate,
k. evaporating the solvent in order to obtain a powder of nanoparticles,
l. heat treatment of the powder of nanoparticles at a temperature comprised between 100 and 1,000° C. under an atmosphere of an inert gas, and
m. washing the treated catalytic powder in order to obtain nanoparticles.

37. The method according to claim 35, wherein the amount of the MOF compound introduced in step j is comprised between 10 and 20% by mass based on the carbon mass introduced in step j with the compound MOF.

38. The method according to claim 35, wherein said method further comprises in step j, the introduction under an inert atmosphere and at room temperature of a support into the mixture obtained in step i.

39. The method according to claim 35, wherein the support consists of carbon nanotubes.

40. Nanoparticles, wherein said nanoparticles are obtained by the method according to 31.

41. Nanoparticles, wherein said nanoparticles are obtained by the method according to 35.

42. An ink comprising nanoparticles according claim 23.

43. A hydrogen fuel cell cathode comprising nanoparticles according to claim 23.

44. A hydrogen fuel cell cathode comprising nanoparticles according to claim 23.

45. A hydrogen fuel cell cathode comprising nanoparticles according to claim 23.

46. The cathode according to claim 45, wherein the nanoparticles are deposited on the surface of the cathode by means of an ink according to claim 42.

47. A method for the reduction reaction of dioxygen (RRO) in an acid medium, wherein said method involves nanoparticles according to claim 23.
